(19) United States
(12) Patent Application Publication
(10) Pub. No.: US 2010/0270400 A1
(43) Pub. Date: Oct. 28, 2010

(54) DISPENSING DEVICE

(75) Inventors: Scott D. Evar, Cleveland, OH (US); James P. Nagy, SR., Cleveland, OH (US); Eric McCarty, Strongsville, OH (US)

Correspondence Address: FAY SHARPE LLP, 1228 Euclid Avenue, 5th Floor, The Halle Building, Cleveland, OH, 44115, US

(73) Assignee: TWENTY TEN, LLC, Cleveland, OH (US)

(21) Appl. No.: 12/765,355

(22) Filed: Apr. 22, 2010

Related U.S. Application Data
(60) Provisional application No. 61/171,575, filed on Apr. 22, 2009.

(51) Int. Cl. B05B 7/04; B05B 7/24

(52) U.S. Cl. 239/414; 239/418; 239/306

(57) ABSTRACT

A dispensing gun for at least two fluid components comprises a gun body having a front section and a middle section. Two needles each have a valve on a forward wall, a socket at a rear section, and a flow path running from the socket to the forward wall. The forward walls of the two needles are received in a flow connector located in the front section. Hoses are connected to the sockets of the two needles and fixed in place relative to a back wall of the gun body. The needles are located in the middle section and move between a dispensing position and a safety position. The fluid components are handled within the interior parts of the gun and do not contact the gun body itself.

### BACKGROUND

This application claims priority to U.S. Provisional Patent Application Ser. No. 61/171,575, filed Apr. 22, 2009. The entire disclosure of that provisional application is hereby fully incorporated by reference herein.

The present disclosure relates to dispensing devices for fluid materials, such as dispensing guns. These devices are suitable for, among other things, mixing and dispensing at least two reactive fluids to form settable polymer products such as adhesives, coatings, foams, and elastomers.

Certain products, including polyurethane foam, can be supplied as two separate components, i.e. an “A” component and a “B” component. The A component is typically a polymeric isocyanate and the B component is many times a polyol amine. They are generally supplied in two different containers which are attached by hoses to a dispensing gun. In the dispensing gun, the fluid components are brought into contact with each other in a mixing chamber where they react and then are quickly dispensed through a nozzle to a desired location. In the dispensing gun, the fluid components are kept separate until they exit the gun. In the nozzle, the fluid components are brought into contact with each other in a mixing chamber where they react and then are quickly dispensed to a desired location.

When the two fluid components are mixed, the reactive mixture quickly forms a set, rigid foam product which is substantially insoluble and very difficult to remove. This includes the nozzle, making cleanup very difficult. As a result, the nozzle of the dispensing gun is typically designed to be replaceable so that the dispensing gun can be reused.

The dispensing gun is generally made from plastic parts and due to cost considerations should be relatively inexpensive to manufacture. The design of a dispensing gun can affect the overall cost of the dispensing gun, its ease of use, cleanup, etc. Hence, it would be beneficial to produce a dispensing device which exhibits one or more of these features. In particular, it would be useful to provide a cartridge system which allows for separation of the internal parts that contact the reactive fluids from the external and visible parts of the dispensing device. This would also allow for several external designs to be used with the same set of internal parts.

### BRIEF DESCRIPTION

Disclosed in various embodiments are dispensing devices for receiving and mixing at least two different reactive fluid components. The dispensing devices are particularly suitable for applications where the reactive fluid components form a settable polymer end product.

Disclosed in some embodiments is a dispensing gun comprising a body, two needles, a flow connector, a trigger, and two hose barbs. The body comprises an external front wall having two ports, an internal front wall, and a back wall. The internal front wall and the back wall extending laterally to divide the body into a front section and a middle section. Each of the two needles comprises a needle valve extending from a forward wall, a socket at a rear section of the needle, and a flow path running from the socket to a forward section of the needle. The flow connector is sized to fit within the front section of the body and comprises two parallel dispensing passages. Each dispensing passage runs from a rear inlet to a forward outlet, the forward outlets extending through the two ports in the external front wall. The trigger comprises a yoke portion having a pair of openings through which the first and second needles extend, and a trigger lever extending from the yoke portion. Each of the two hose barbs comprises a sidewall defining a flow passage and an indent cooperating with the back wall to hold the hose barb in a fixed location. Each hose barb is received in the socket of one of the two needles so that the hose barb flow passage aligns with the needle flow path of that needle. The rear inlets of the flow connector receive the forward sections of the first and second needles and the two needle valves are aligned with the two forward outlets. The two needles are movable within the middle section between a safety position in which the two needle valves extend into the two forward outlets and a dispensing position permitting flow from the two needle sockets through the two forward outlets.

The back wall of the body may also define a rear section within the body for receiving two hoses. The needle flow path may exit through the forward wall of each needle.

A forward shoulder on each needle may cooperate with an internal surface in the body to define the safety position. The internal surface can be the internal front wall or another wall located between the internal front wall and the back wall. The forward shoulder on each needle may be located between the forward section of the needle and the yoke portion of the trigger, or between the yoke portion of the trigger and the socket of the needle.

A rear shoulder on each needle may cooperate with the back wall of the body to define the dispensing position.

In some embodiments, the first needle has a prong, and the second needle has a slot for engaging the prong. This provides a means for locking the needles so that they move in unison as well as eliminating trigger bias and off ratio risk.

The trigger may further comprise a trigger pivot extending from the yoke portion opposite the trigger lever. The trigger pivot can extend into a recess in a top wall of the body which coordinates the movement of the trigger pivot.

The yoke portion may comprise a first crossbar from which a trigger pivot extends and a second crossbar from which the trigger lever extends. The second crossbar is longer than the first crossbar.

The dispensing gun may further comprising a spring having two opposing free ends, one free end engaging a catch on the trigger lever and the other free end engaging a catch on a handle extending from the body.

Each needle may further comprise a reduced width portion for engaging the yoke portion of the trigger.

The dispensing gun may further comprise two nozzle recesses spaced along the external front wall of the body. The nozzle may comprise a nozzle base, a mixing, element, and a nozzle tip. The nozzle base has two snap fasteners on a first side, a male thread on a second side, and two bores running from the first side to the second side, the two bores aligning with the two forward outlets of the flow connector. The nozzle tip has a tip outlet, a female thread at a tip inlet, and a mixing chamber in fluid communication with the tip inlet and tip outlet. The mixing element is located within the mixing chamber and the two snap fasteners are inserted into two nozzle recesses spaced along the external front wall of the body when placed on the dispensing gun.

The gun body may be formed from a gun cap and a gun base.

Disclosed in other embodiments is a dispensing gun comprising a body, a needle assembly, and a hose assembly. The body comprises an external front wall having at least two ports, an internal front wall, and a back wall. The internal front wall and the back wall extend laterally to divide the body into a front section and a middle section. The needle assembly comprises at least two needle valves extending from a forward wall, at least two connectors at a rear section of the needle assembly, and at least two separate flow paths running from the at least two connectors to a forward section of the needle. The hose assembly is capable of receiving at least two hoses and includes at least two separate flow passages and an indent cooperating with the back wall to hold the hose assembly in a fixed location. Each flow passage engages one of the connectors of the needle assembly and aligns with a needle flow path. The needle assembly is movable within the middle section between a safety position in which the at least two needle valves prevent flow through the at least two ports of the external front wall and a dispensing position permitting flow from the at least two needle connectors to the at least two ports of the external front wall.

The dispensing gun may further comprise a flow connector sized to fit within the front section of the body. The flow connector includes at least two parallel dispensing passages, each dispensing passage running from a rear inlet to a forward outlet. The forward outlets extend through the two ports in the external front wall. The rear inlet is configured to engage the forward section of the needle assembly so that each flow path of the needle assembly aligns with one dispensing passage.

The needle assembly may further comprise a reduced width portion for engaging the yoke portion of a trigger. The back wall of the body may also define a rear section within the body for receiving at least two hoses. Each needle flow path may exit through the forward wall of the needle assembly.

A forward shoulder on the needle assembly may cooperate with an internal surface in the body to define the safety position. The internal surface may be the internal front wall, or another wall located between the internal front wall and the back wall. A rear shoulder on the needle assembly may cooperate with the back wall of the body to define the dispensing position.

The needle assembly may comprise two needles, one needle having a prong, and the other needle having a slot for engaging the prong.

Disclosed in still other embodiments is a dispensing gun comprising a body, two needles, a flow connector, a trigger, two hose barbs, and a spring. The body comprises an external front wall having two ports, a top wall having a recess, an internal front wall, an internal back wall, and a handle having a catch. The internal walls extend laterally to divide the body into a front section, a middle section, and a rear section. The two needles each comprise a needle valve extending from a forward wall, a socket at a rear section of the needle, a flow path running from the socket to the forward wall of the needle, a forward shoulder, a rear shoulder, and a yoke engaging section. The flow connector is sized to fit within the front section of the body and comprises two parallel dispensing passages. Each dispensing passage runs from a rear inlet to a forward outlet. The forward outlets extend through the two ports in the external front wall of the gun body. The trigger comprises a yoke portion having a pair of openings that engage the yoke engaging sections of the two needles, a trigger lever extending from the yoke portion and having a catch, and a trigger pivot extending from the yoke portion opposite the trigger lever into the recess of the body. Each hose barb comprises a sidewall defining a flow passage and an indent cooperating with the back wall to hold the hose barb in a fixed location. Each hose barb is received in the socket of one of the two needles so that the hose barb flow passage aligns with the needle flow path of that needle. The spring has two opposing free ends, one free end engaging the trigger lever catch and the other free end engaging the handle catch. The rear inlets of the flow connector receive the forward walls of the first and second needles and the two needle valves are aligned with the two forward outlets. The two needles are movable within the middle section between a safety position in which the two needle valves extend into the two forward outlets and a dispensing position permitting flow from the two needle sockets through the two forward outlets.

Also disclosed are kits including the dispensing guns described herein. The kits also include one or more pressurized containers containing at least two fluid components; and one or more hoses capable of providing a separate channel for each fluid component in the one or more pressurized containers.

Disclosed in some embodiments is a dispensing gun comprising a body, two needles, a flow connector, a trigger, and two hose barbs. The body comprises an external front wall having two ports, an internal front wall, and a back wall. The internal front wall and the back wall extend laterally to divide the body into a front section and a middle section. Each needle comprises a needle valve extending from a forward section, an outlet on the forward section, a socket at a rear section of the needle, a socket spring located within the socket, and a flow path running from the socket to the outlet of the needle. The flow connector is sized to fit within the front section of the body and comprises two parallel dispensing passages. Each dispensing passage runs from a rear inlet to a forward outlet, and the forward outlets extend through the two ports in the external front wall. The trigger comprises a yoke portion having a pair of openings through which the first and second needles extend, and a trigger lever extending from the yoke portion. Each hose barb comprises a sidewall defining a flow passage and an indent cooperating with the back wall to hold the hose barb in a fixed location. Each hose barb is received in the socket of one of the two needles so that the hose barb flow passage aligns with the needle flow path. The rear inlets of the flow connector receive the forward sections of the first and second needles and the two needle valves are aligned with the two forward outlets. The two needles are movable within the middle section between a safety position in which the two needle valves extend into the two forward outlets and a dispensing position permitting flow from the two needle sockets through the two forward outlets.

The needle flow path may exit through an outlet located on an angled forward wall of each needle.

In some embodiments, the forward section has a diameter, the socket has a diameter, and the forward section diameter is less than the socket diameter. The back wall of the body can also define a rear section within the body for receiving two hoses.

A forward shoulder on each needle may cooperate with an internal surface in the body in the safety position. That internal surface may be the internal front wall, or another surface located between the internal front wall and the back wall. The forward shoulder itself can be located between the forward section of the needle and the yoke portion of the trigger, or between the yoke portion of the trigger and the socket of the needle. A rear shoulder on each needle can also cooperate with the back wall of the body in the dispensing position.

The two needles may have different shapes to ensure their correct orientation within the body of the dispensing gun. In particular embodiments, the first needle has a prong, and the second needle has a slot for engaging the prong.

The trigger may further comprise a trigger pivot extending from the yoke portion opposite the trigger lever. The trigger pivot extends into a trigger recess extending beyond a top wall of the body. Each needle may further comprise a reduced width portion for engaging the yoke portion of the trigger.

The dispensing gun may further comprise two nozzle recesses spaced along a front ring wall of the body. Those nozzle recesses can interact with a nozzle. In particular, embodiments, the nozzle comprises a nozzle base, a mixing element, a nozzle tip, and a mixing chamber. The nozzle base has two snap fasteners on a first side, a male thread on a second side, and two bores running from the first side to the second side. The two bores align with the two forward outlets of the dispensing gun. The nozzle tip has a tip outlet and a female thread at a tip inlet. The mixing chamber is in fluid communication with the tip inlet and tip outlet. The mixing element is located within the mixing chamber and the two snap fasteners are inserted into the two nozzle recesses.

The body may be formed from a gun cap and a gun base. In embodiments, the external front wall is located on the gun base, the external front wall further comprises a groove, the gun cap comprises a tongue, and the gun cap tongue engages the external front wall groove.

Fastener slots are used to connect the gun cap and gun base together. The gun cap and the gun base may each comprise a front fastener slot, a back fastener slot, and/or two rear fastener slots in various combinations discussed herein.

Disclosed in other embodiments is a dispensing gun comprising a body, a needle assembly, and a hose assembly. The body comprises an external front wall having at least two ports, an internal front wall, and a back wall. The internal front wall and the back wall extend laterally to divide the body into a front section and a middle section. The needle assembly comprises at least two needle valves extending from a forward section, at least two outlets in the forward section, at least two sockets at a rear section of the needle assembly, a socket spring in each socket, and at least two separate flow paths running from the at least two sockets to the angled forward section. The hose assembly receives at least two hoses. The hose assembly includes at least two separate flow passages and an indent cooperating with the back wall to hold the hose assembly in a fixed location. Each flow passage engages one of the sockets of the needle assembly and aligns with the needle flow path. The needle assembly is movable within the middle section between a safety position in which the at least two needle valves prevent flow through the at least two ports of the external front wall and a dispensing position permitting flow from the at least two needle connectors to the at least two ports of the external front wall.

The dispensing gun may further comprise a flow connector sized to fit within the front section of the body. The flow connector includes at least two parallel dispensing passages, each dispensing passage running from a rear inlet to a forward outlet. The forward outlets extend through the two ports in the external front wall. The rear inlet is configured to engage the forward section of the needle assembly so that each flow path of the needle assembly aligns with one dispensing passage.

The back wall of the body may also define a rear section within the body for receiving at least two hoses.

Also disclosed is a dispensing gun comprising a body, a first needle and a second needle, a flow connector, a trigger, and a first hose barb and a second hose barb. The body comprises an external front wall having two ports, a trigger recess extending beyond a top wall, an internal front wall, an internal back wall, and a handle having a catch. The internal walls extend laterally to divide the body into a front section, a middle section, and a rear section. Each needle comprises a needle valve extending from an angled forward wall, an outlet in the angled forward wall, a socket at a rear section of the needle, a socket spring in the socket, a flow path running from the socket to the outlet, a forward shoulder, a rear shoulder, and a yoke engaging section. The flow connector is sized to fit within the front section of the body and comprises two parallel dispensing passages, each dispensing passage running from a rear inlet to a forward outlet, the forward outlets extending through the two ports in the external front wall. The trigger comprises a yoke portion having a pair of openings that engage the yoke engaging sections of the two needles, a trigger lever extending from the yoke portion, and a trigger pivot extending from the yoke portion opposite the trigger lever into the trigger recess. Each hose barb comprises a sidewall defining a flow passage and an indent cooperating with the back wall to hold the hose barb in a fixed location. Each hose barb is received in the socket of one of the two needles so that the hose barb flow passage aligns with the needle flow path. The rear inlets of the flow connector receive the forward walls of the first and second needles and the two needle valves are aligned with the two forward outlets. The two needles are movable within the middle section between a safety position in which the two needle valves extend into the two forward outlets and a dispensing position permitting flow from the two needle sockets through the two forward outlets.

Also disclosed are kits including the dispensing guns described herein. The kits also include one or more pressurized containers containing at least two fluid components; and one or more hoses capable of providing a separate channel for each fluid component in the one or more pressurized containers.

These and other non-limiting aspects and/or objects of the disclosure are more particularly described below.

### BRIEF DESCRIPTION OF THE DRAWINGS

The following is a brief description of the drawings, which are presented for the purposes of illustrating the disclosure set forth herein and not for the purposes of limiting the same.

FIG. 1 is a diagram showing the interior configuration of an exemplary dispensing gun of the present disclosure.

FIG. 2 shows an exemplary dispensing gun with a detachable nozzle of the present disclosure.

FIG. 3 is a side view of an exemplary gun base of the present disclosure.

FIG. 4 is a top view of an exemplary gun base of the present disclosure.

FIG. 5 is a bottom view of an exemplary gun base of the present disclosure.

FIG. 6 is a front view of an exemplary gun base of the present disclosure.

FIG. 7 is a back view of an exemplary gun base of the present disclosure.

FIG. 8 is a bottom perspective view of an exemplary gun base of the present disclosure.

FIG. 9 is a top perspective view of an exemplary gun base of the present disclosure.

FIG. 10 is a top exterior view of an exemplary gun cap of the present disclosure.

FIG. 11 is a side cross-sectional view of an exemplary gun cap of the present disclosure along line A-A of FIG. 8.

FIG. 12 is a bottom interior view of an exemplary gun cap of the present disclosure.

FIG. 13 is a top perspective view of an exemplary gun cap of the present disclosure.

FIG. 14 is a bottom perspective view of an exemplary gun cap of the present disclosure.

FIG. 15 illustrates various views of an exemplary flow connector used in the dispensing gun of the present disclosure.

FIG. 16 illustrates various views of an exemplary first needle used in the dispensing gun of the present disclosure.

FIG. 17 illustrates various views of an exemplary second needle used in the dispensing gun of the present disclosure.

FIG. 18 illustrates various views of an exemplary trigger used in the dispensing gun of the present disclosure.

FIG. 19 illustrates various views of an exemplary hose barb used in the dispensing gun of the present disclosure.

FIG. 20 illustrates various views of an exemplary spring used in the dispensing gun of the present disclosure.

FIG. 21 is a diagram illustrating a first stage of assembly of the dispensing gun of the present disclosure.

FIG. 22 is a diagram illustrating a second stage of assembly of the dispensing gun of the present disclosure.

FIG. 23 illustrates various views of an exemplary nozzle base used in the nozzle of the present disclosure.

FIG. 24 illustrates various views of a first exemplary embodiment of a nozzle tip used in the nozzle of the present disclosure.

FIG. 25 illustrates various views of a second exemplary embodiment of a nozzle tip used in the nozzle of the present disclosure.

FIG. 26 is a top view of a second exemplary gun base of the present disclosure.

FIG. 27 is a side view of a second exemplary gun base of the present disclosure.

FIG. 28 is a bottom view of a second exemplary gun base of the present disclosure.

FIG. 29 is a front view of a second exemplary gun base of the present disclosure.

FIG. 30 is a back view of a second exemplary gun base of the present disclosure.

FIG. 31 is a top perspective view of a second exemplary gun base of the present disclosure.

FIG. 32 is a top exterior view of a second exemplary gun cap of the present disclosure.

FIG. 33 is a side view of a second exemplary gun cap of the present disclosure.

FIG. 34 is a bottom interior view of a second exemplary gun cap of the present disclosure.

FIG. 35 illustrates various views of a second exemplary flow connector used in a second exemplary dispensing gun of the present disclosure.

FIG. 36 illustrates various views of a second exemplary needle used in a second exemplary dispensing gun of the present disclosure.

FIG. 37 illustrates various views of an exemplary socket spring used in a second exemplary dispensing gun of the present disclosure.

FIG. 38 illustrates various views of a second exemplary trigger used in a second exemplary dispensing gun of the present disclosure.

FIG. 39 is a diagram illustrating the assembly of the second exemplary dispensing gun of the present disclosure.

### DETAILED DESCRIPTION

A more complete understanding of the processes and apparatuses disclosed herein can be obtained by reference to the accompanying drawings. These figures are merely schematic representations based on convenience and the ease of demonstrating the existing art and/or the present development, and are, therefore, not intended to indicate relative size and dimensions of the assemblies or components thereof.

Although specific terms are used in the following description for the sake of clarity, these terms are intended to refer only to the particular structure of the embodiments selected for illustration in the drawings, and are not intended to define or limit the scope of the disclosure. In the drawings and the following description below, it is to be understood that like numeric designations refer to components of like function.

Generally speaking, the dispensing device or dispensing gun of the present disclosure is constructed so that the parts which contact the fluid components are inside and separate from an exterior of the dispensing gun. This interior “cartridge” design simplifies repackaging of the gun with various exterior designs.

The dispensing gun of the present disclosure comprises (a) a gun body; (b) two needles; (c) optionally, a flow connector; and (d) a hose assembly by which the containers containing the A and B components can be attached to the dispensing gun.

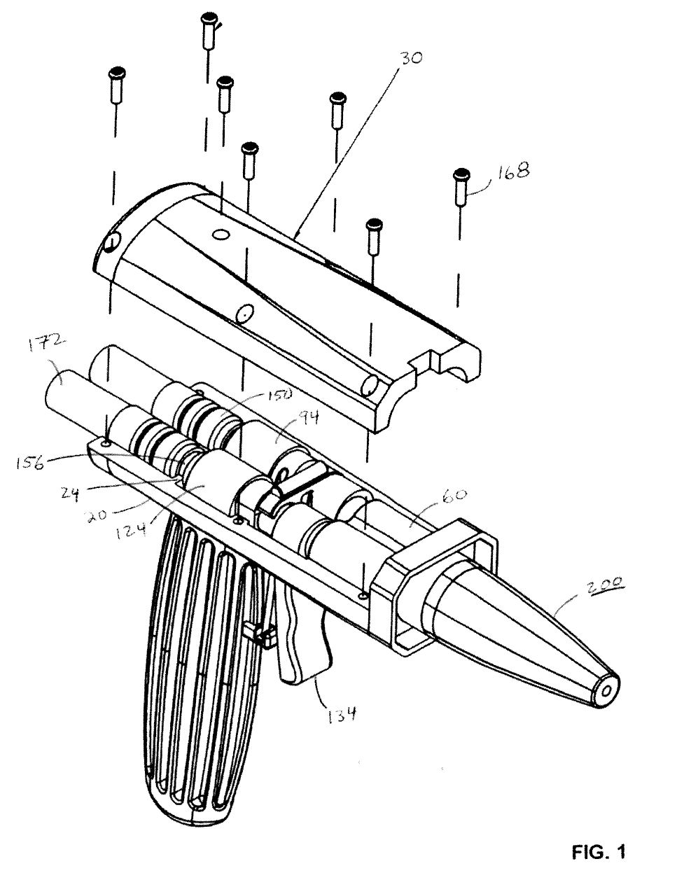

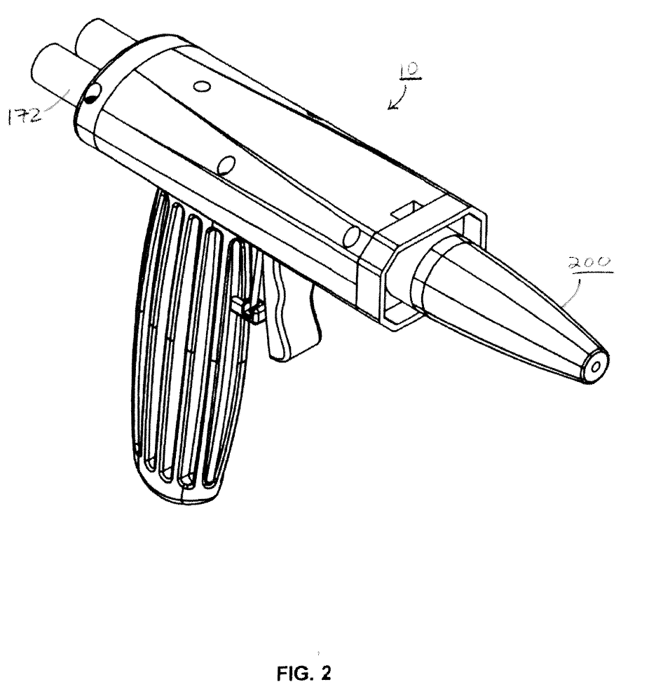

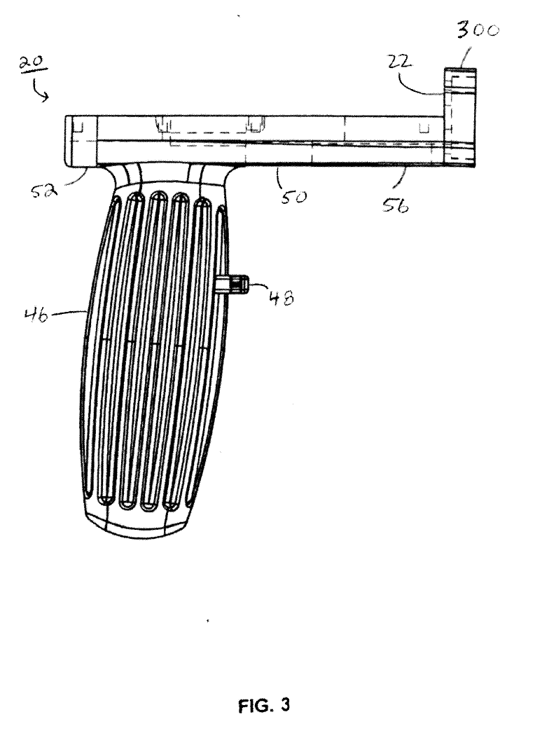

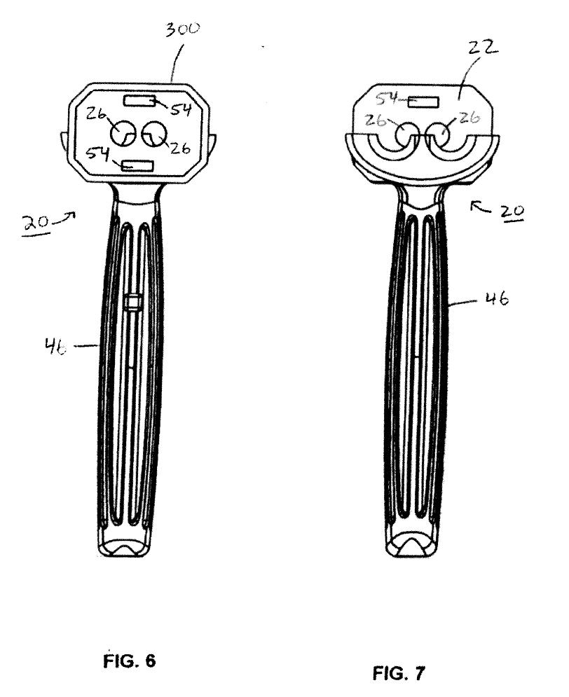

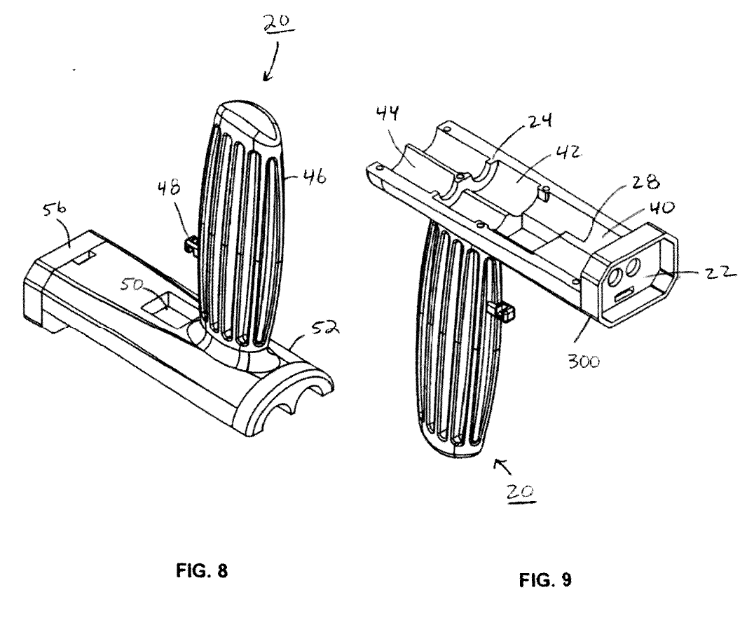

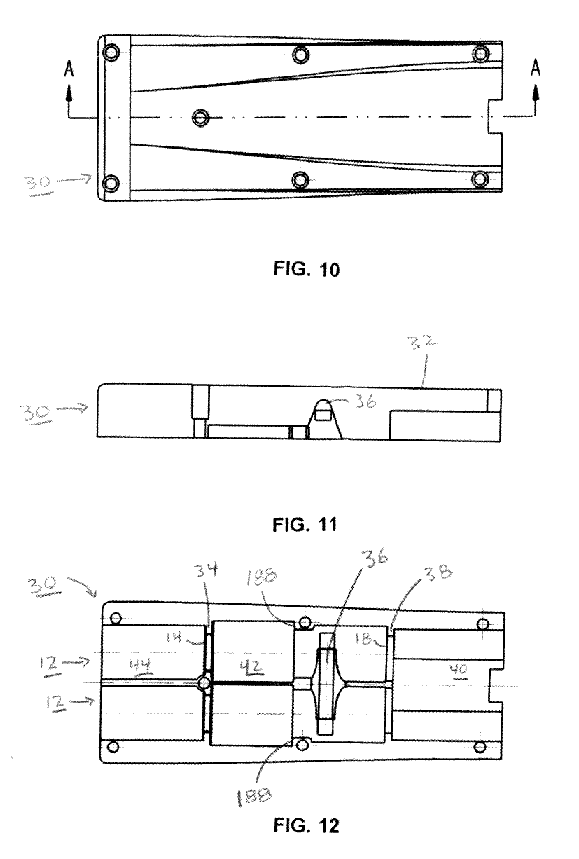

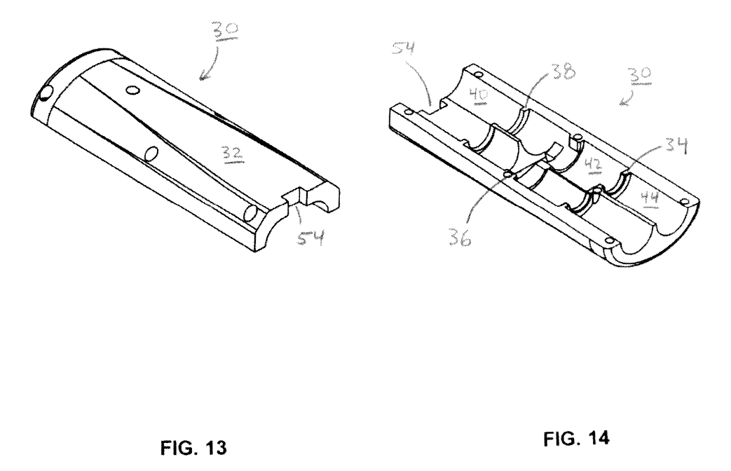

The gun body provides a housing and has a hollow internal chamber. As shown in FIGS. 1 and 2, the gun body 10 is typically made as two separate components, a gun base 20 and a gun cap 30. FIGS. 3-9 show different views of the gun base 20, while FIGS. 10-14 show different views of the gun cap 30. These components can be made from a wide variety of materials, including synthetic polymers or elastomeric materials, metals, etc. The components can also be produced and using a wide variety of techniques, such as molding.

The gun body 10 extends longitudinally from an external front wall to a back wall. The external front wall 22 is typically located on the gun base 20, while the back wall 14 is typically formed from portions of both the gun base (see reference numeral 24) and the gun cap (see reference numeral 34). The external front wall 22 has two apertures or ports 26 which connect the interior of the gun body to the outside environment. Similar to the back wall 14, an internal front wall 18 is typically formed from portions of both the gun base (see reference numeral 28) and the gun cap (see reference numeral 38). The internal front wall 18 is located between the external front wall 22 and the back wall 14. The gun base 20, gun cap 30, internal front wall 18, and the back wall 14 are shaped to form two parallel chambers 12 extending through the gun body. The parallel chambers 12 are generally open ended, laterally displaced, straight, and substantially similar to each other. The internal front wall 18 and the back wall 14 extend laterally, dividing the interior of the gun body into a front section 40, middle section 42, and optionally a rear section 44.

A handle 46 extends substantially transversely from the exterior of the gun base 20. A catch 48 is located on the handle. As will be explained later, a biasing mechanism (such as a spring) engages the catch 48. A trigger cavity 50 is located proximate the handle 46 and also connects the interior of the gun body with the external environment. The handle 46 may be located at either end of the gun base, but is generally positioned near a back end 52 of the gun base.

Two nozzle receiving recesses 54 are spaced along the external front wall 22 of the gun body and extend into a bottom wall 56 of the gun base and a top wall 32 of the gun cap. The nozzle receiving recesses cooperate with snap fasteners 212 on the nozzle 200 (see FIG. 22) to attach the nozzle to the dispensing gun. A generally U-shaped trigger recess 36 is also located in the top wall 32 of the gun body.

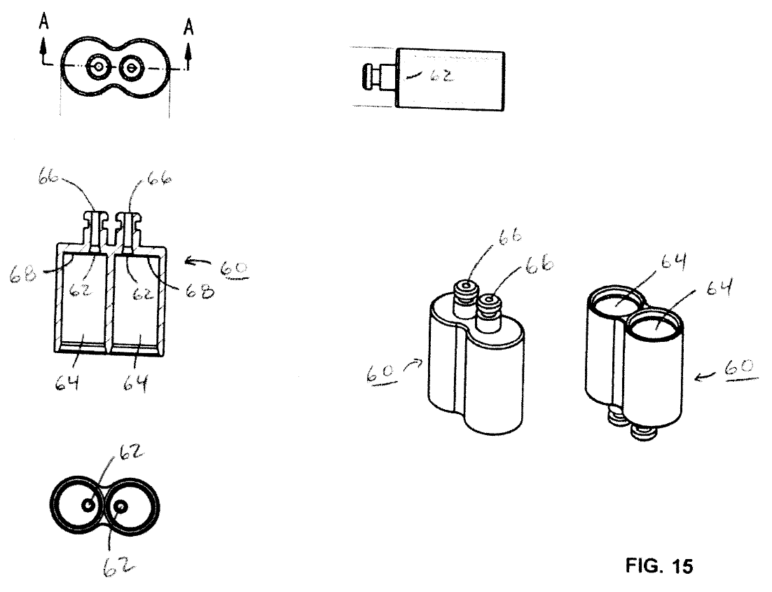

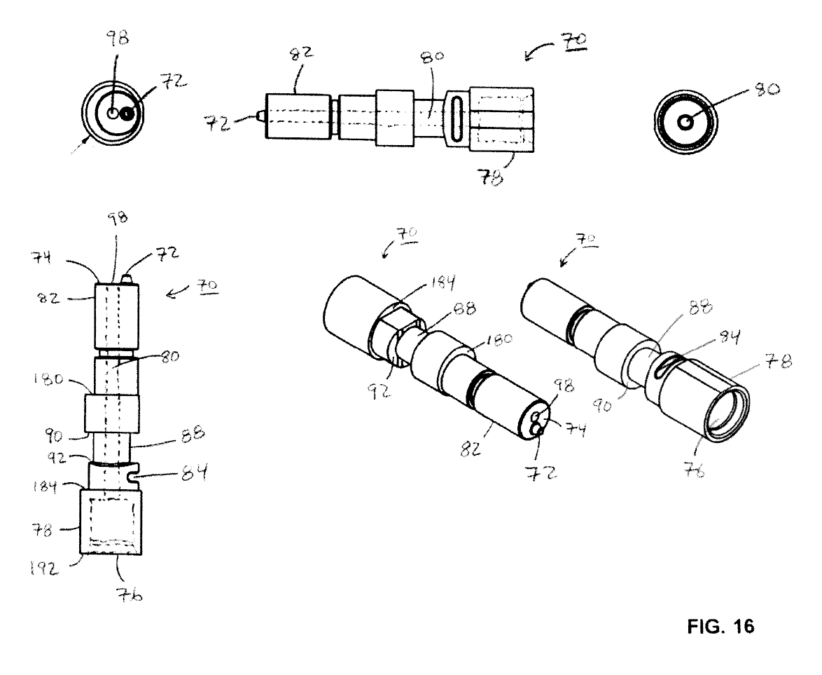

FIG. 15 shows various views of a flow connector 60. The flow connector 60 is sized to fit snugly within the front section 40 of the gun body 10. In other words, the flow connector does not move within the front section 40. The flow connector contains two parallel dispensing passages 62 which are separate from each other. Each dispensing passage runs from a rear inlet 64 to a forward outlet 66. The forward outlets extend through the ports 26 in the external front wall 22, and in some embodiments beyond the external front wall. The rear inlets are sized to receive forward sections 82, 112 of the two needles 70, 100.

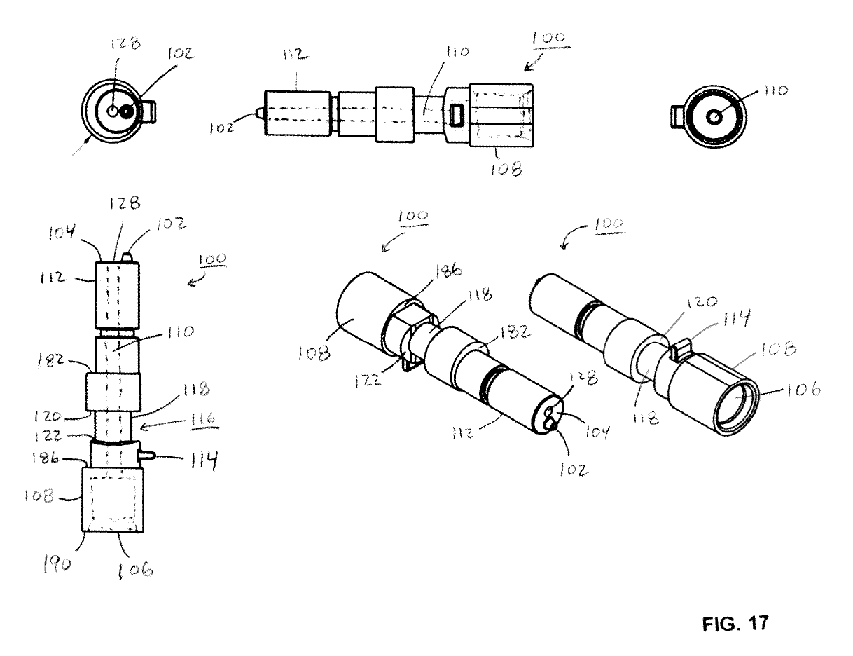

FIGS. 16 and 17 show various views of two needles 70, 100. The two needles are placed within the middle portion 42 of the gun body 10 and may be considered a needle assembly. Each needle has a needle valve 72, 102 extending from a forward wall 74, 104. The needle valve has a conical shape. A connector 76, 106, such as a socket, is present on a rear section 78, 108 of each needle. A flow path 80, 110 runs from the rear section to the forward section 82, 112 of each needle. Generally, the flow path is formed as a longitudinal bore. Generally, the flow path also exits through the forward wall 74, 104 of each needle. However, it is contemplated that the flow connector 60 and forward section 82, 112 could be complementarily shaped so that fluid components pass to the forward outlet of the flow connector 60 by a different path. When the flow path 80, 110 exits through the forward wall, it generally exits from an outlet 98, 128 placed laterally relative to the needle valve 72.

In some embodiments, the two needles are complementarily shaped so that they have directionality. For example, second needle 100 may have a prong 114, and first needle 70 has a slot 84 for engaging the prong. Generally, the two needles have complementary receptors for providing directionality.

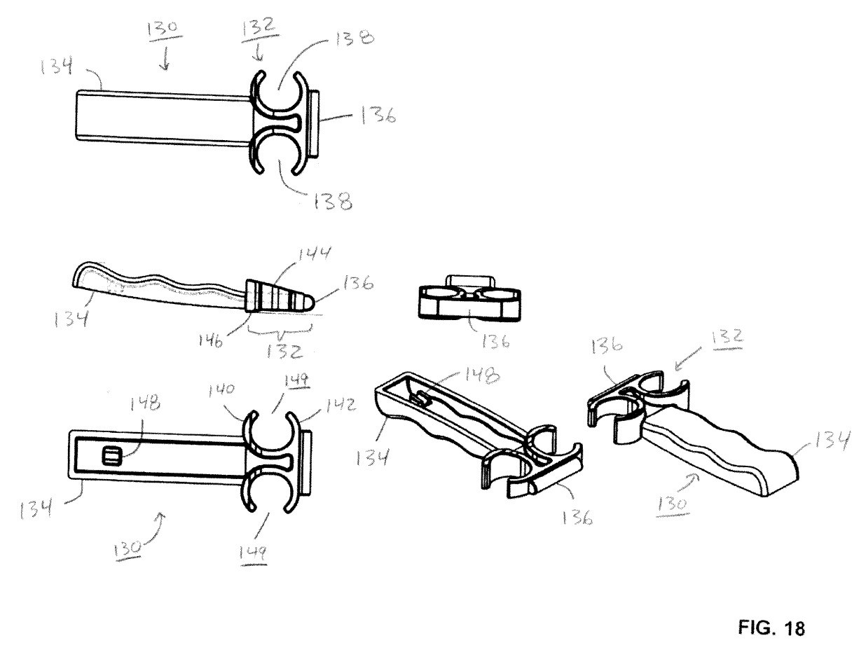

In addition, the two needles include a yoke engaging section 86, 116 for engaging the trigger (see FIG. 18). Broadly speaking, the yoke engaging section can be described as a portion having reduced width compared to adjacent sections of the needle. For example, each needle has a reduced width 88, 118, which also defines a first lateral wall 90, 120 and a second lateral wall 92, 122.

FIG. 18 shows various views of the trigger 130. The trigger comprises a yoke portion 132, a trigger lever 134 extending from the yoke portion, and a trigger pivot 136 extending from the yoke portion opposite the trigger lever 134. The yoke portion 132 has a pair of openings 138 through which the two needles 70, 100 extend. Put another way, the yoke portion 132 engages the yoke engaging sections 86, 116 of the two needles 70, 100. The yoke portion 132 comprises a first crossbar 140 and a second crossbar 142. The second crossbar 142 is longer than the first crossbar 140, where the length is measured in the longitudinal direction (i.e. parallel to the two needles). Put another way, the first and second crossbars define a first lateral wall 144 and a second lateral wall 146 which interact with the first and second lateral walls of the two needles. The first lateral wall 144 is angled towards the trigger pivot 136. The sides 149 of the yoke portion are removed so that the needles 70, 100 are inserted into the yoke portion 132 from the side. The trigger also includes a catch 148 for engaging a biasing mechanism. The catch 148 is located on the trigger lever 134, generally distal from the yoke portion 132. The trigger lever 134 may be contoured to conform to the shape of a user's fingers.

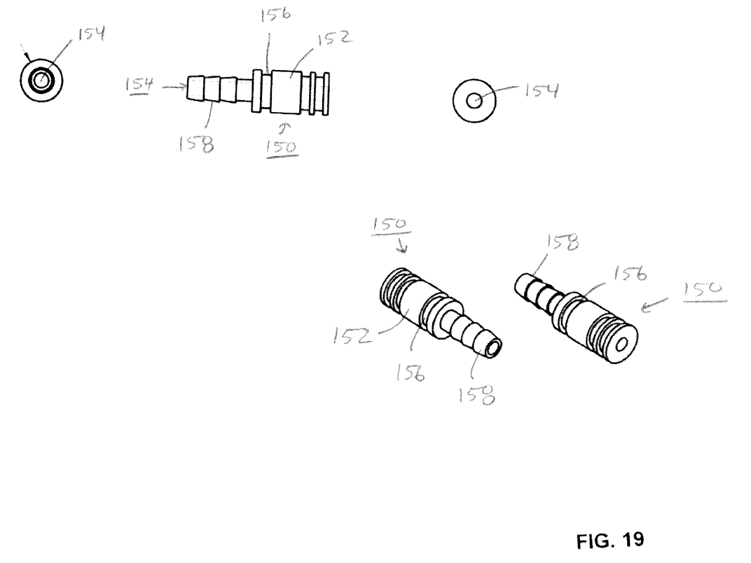

An exemplary embodiment of a hose assembly is shown in FIG. 19 as a hose barb 150. The hose barb 150 is formed from a sidewall 152 that defines a flow passage 154. An indent 156 in the sidewall 152 cooperates with the back wall 14 of the gun body 10, so that the hose assembly remains in a fixed location (i.e. is fixed in place), particularly relative to the gun body 10. A hose connector 158 forms a rear portion of the hose barb 150. The hose connector may be a conventional quick connect coupling or retaining mechanism.

It is also contemplated that a hose assembly having essentially the same structure as the hose barb may be used. In other words, the hose assembly would define at least two separate flow passages and have a common indent for cooperating with the back wall 14 of the gun body.

The needles 70, 100 and the hose assembly/hose barbs 150 are also shaped to allow seals, such as O-rings, to be used. As depicted in FIGS. 16 and 17, the needles are shaped to accept one O-ring, while the hose barb 150 accepts two O-rings. These seals prevent fluid component from escaping out the various components into the gun body itself.

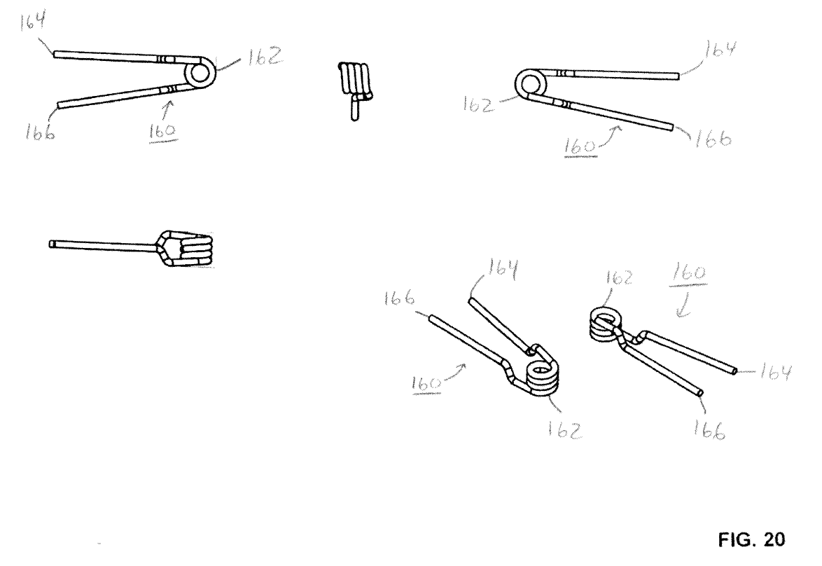

FIG. 20 shows a spring 160 used as a biasing mechanism. The spring 160 has a coil 162 located between two opposing free ends 164, 166. The free ends are inserted into the trigger lever catch 148 and the handle catch 48.

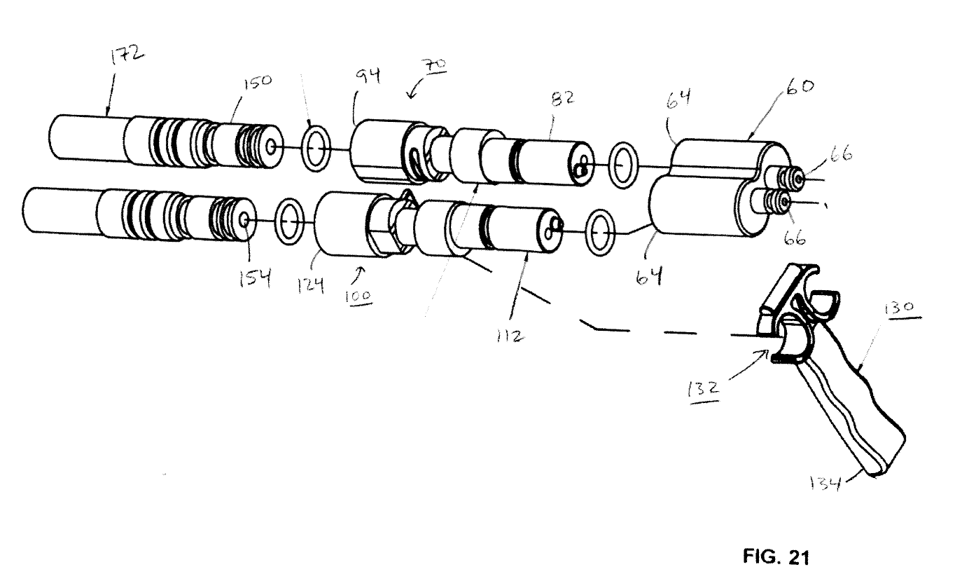

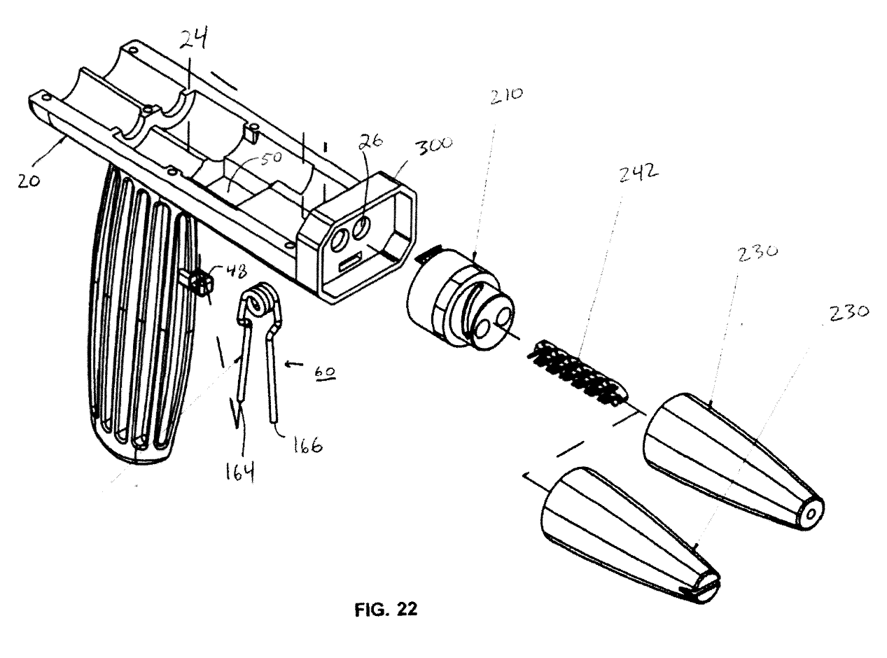

FIGS. 21 and 22 show the dispensing gun in various stages of assembly and show the interrelation of the various components. Referring to FIG. 21, the two needles 70, 100 are inserted into the yoke portion 132 of the trigger 130 and aligned so the prong 114 of the second needle engages the slot 84 of the first needle. The forward sections 82, 112 of the needles 70, 100 are inserted into, or received by, the rear inlets 64 of the flow connector 60. The hose assembly (here, two hose barbs 150 shown attached to hoses 172) engage connectors 76, 106 on the needles so that the flow passage 154 of each hose barb aligns with the flow path 80, 110 of a needle. As shown here, each hose barb 150 is received in a socket 94, 124 of a needle.

The sub-assembly of the flow connector 60, needles 70, 100, and hose barbs 150 is then placed in the gun base 20. The trigger cavity 50 is sized so that the forward outlets 66 of the flow connector 60 can be placed into the ports 26 in the external front wall 22 and the trigger lever 134 can be inserted through the trigger cavity 50 while maintaining the sub-assembly. The flow connector 60 fits in the front section 40 and the needles are placed in the middle section 42. The indent 156 of each hose barb is aligned with the back wall portion 24 of the gun base 20, so that the hose barbs do not move in relation to the gun body 10. The needles 70, 100 occupy the parallel chambers 12 in the middle section 42 of the gun body.

The hose assembly is shown in FIG. 21 as being combined with the needles 70, 100 prior to insertion of the sub-assembly into the gun base 20. However, it should be noted that in some cases, it may be easier to make the sub-assembly from just the flow connector 60 and needles 70, 100, insert that sub-assembly into the gun base, then attach the hose assembly to the needles.

Referring to FIG. 22, the free ends 164, 166 of the spring 160 are inserted into the trigger lever catch 148 and the handle catch 48.

Referring to FIG. 1, the gun cap 30 is then attached to the gun base 20 via fasteners 168. FIG. 2 shows the assembled dispensing gun with a nozzle 200 attached. As a result of the assembly of the various parts, the flow passages 154 of the hose barbs 150 are in fluid communication with the forward outlets 66 of the flow connector 60 through the two needles 70, 100. In contrast with many dispensing guns, no springs or similar biasing mechanisms are located inside the gun body.

The two needles 70, 100 are located within the middle section 42 of the gun body. The needles are movable within the middle section between a safety position and a dispensing position. Put another way, the two needles 70, 100 have a length 96, 126 which is less than the length 170 of the middle section. The design of the two needles and the use of only one spring assures that each needle travels equally and in time between the safety position and the dispensing position.

The spring 160 biases the needles into the safety position. In this position, the needle valves 72, 102 are pushed into, or extend into, the two forward outlets 66 of the flow connector 60. The flow path outlets 98, 128 can alternatively be considered as being covered by a sealing surface 68 in the flow connector 60. Put another way, the needle valves 72, 102 prevent the flow of the fluid components through the ports 26 in the external front wall 22.

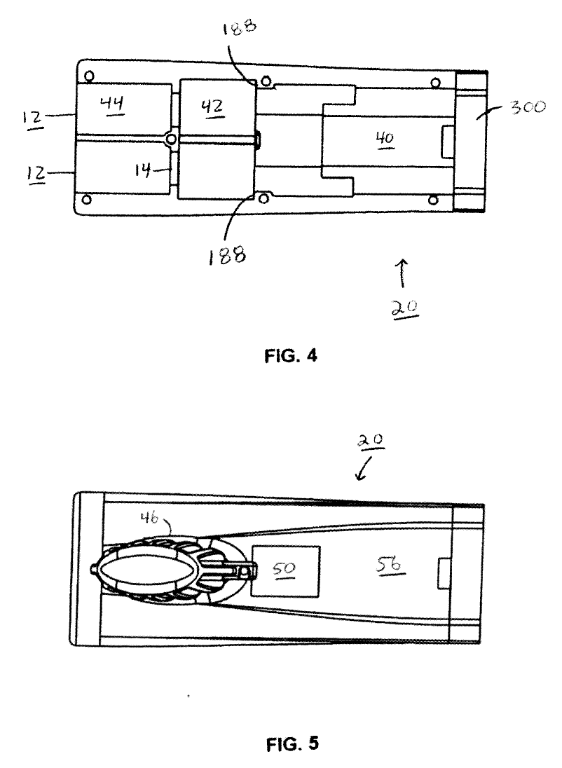

The safety position may also be defined by the interaction between the needles 70, 100 and the gun body 10. In some embodiments, a forward shoulder on each needle cooperates with an internal surface in the gun body to define the safety position. Referring to FIGS. 4, 12, 16, and 17, each needle may have a forward shoulder 180, 182 located between the forward section 82, 112 and either the yoke engaging section 86, 118 or the yoke portion 132 of the trigger. This forward shoulder 180, 182 cooperates with the internal front wall 18 of the gun body, preventing the needles from moving further towards the front section 40 of the gun body (i.e., the internal front wall is the internal surface). Alternatively, each needle may have a forward shoulder 184, 186 located between the connector 76, 106 and either the yoke engaging section 86, 118 or the yoke portion 132 of the trigger. This forward shoulder 184, 186 cooperates with an internal surface 188 located on the gun body 10 between the internal front wall 18 and the back wall 14 to restrict the forward motion of the needles.

Upon a user squeezing the handle 46 and the trigger lever 134 together, the needles move into a dispensing position. The dispensing position may also be defined by the interaction between the needles and the gun body. In some embodiments, a rear shoulder 190, 192 on each needle 70, 100 cooperates with the back wall 14 of the body to restrict the rearward motion of the needles.

The hose assembly 150 can alternatively interact with the connector 76, 106 of each needle to define the dispensing position. For example, the interaction of the hose barb 150 with the connector of each needle can restrict the rearward motion of the needles, such as by changing the length of the portion of the hose barb 150 located within the middle section 42 of the gun body.

The interaction of the trigger pivot 136 with the trigger recess 36 can also define the safety and dispensing positions. The shape of the trigger pivot 136 and the trigger recess 36 together define a pivoting range of motion for the two needles, and that range can be changed by altering their shape. The trigger pivot 136 is not pinned or otherwise connected to the gun body, and can be considered to float within trigger recess 36. When the user squeezes the trigger lever 134 towards the handle 46, trigger pivot 136 pivots within trigger recess 36 and moves the yoke portion 132 into contact with the yoke engaging section 86, 116 of each needle so as to move the needles towards the back wall 14. As the needle valves 72, 102 are pulled rearward, the annular clearance between the needle valve 72, 102 and the forward outlet 66 serves to meter the amount of fluid component dispensed (due to the conical shape of the needle valve). The shape of the needle valve can be varied as desired to change the metering characteristics of the dispensing gun.

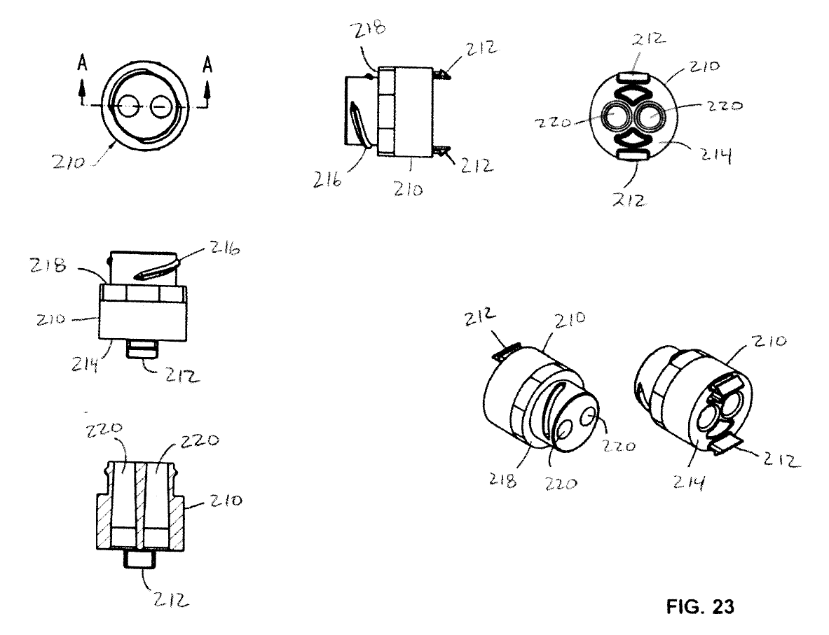

FIGS. 23-25 illustrate exemplary embodiments of a detachable nozzle suitable for use with the dispensing gun. The nozzle 200 generally comprises (i) a nozzle base; (ii) a mixing element; and (iii) a nozzle tip.

FIG. 23 illustrates the detachable nozzle base. The nozzle base 210 has snap fasteners 212 on a first side 214, a male thread 216 on a second side 218, and two bores 220 running from the first side to the second side. The two bores 220 align with the two forward outlets 66 of the flow connector, or with the two ports 26 in the gun body 10. The snap fasteners 212 are inserted into the nozzle recesses 54 of the gun body to connect the nozzle base 210 to the gun body 10. As is understood by those skilled in the art, other mechanisms or structures can also be used on either side of the nozzle base, so long as the gun body 10 and/or nozzle tip 230 are complementarily modified.

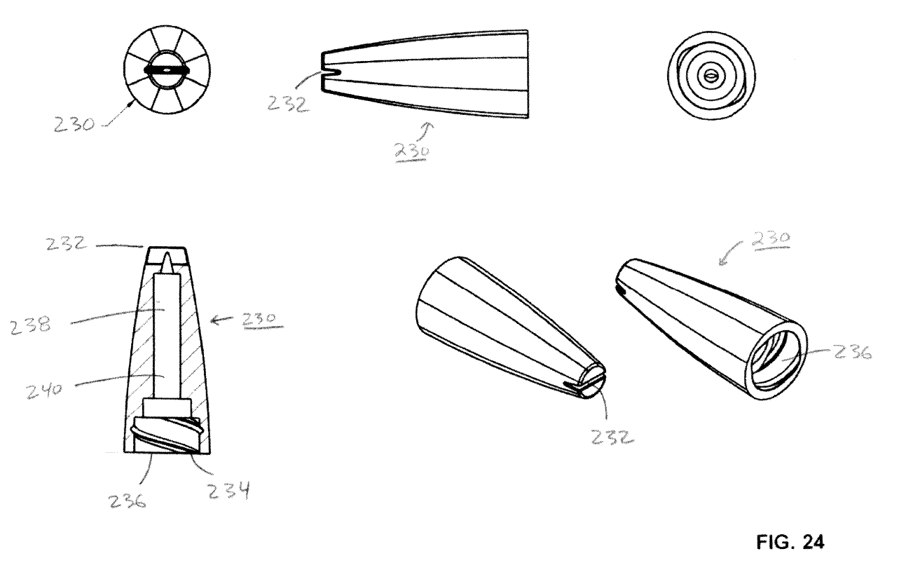

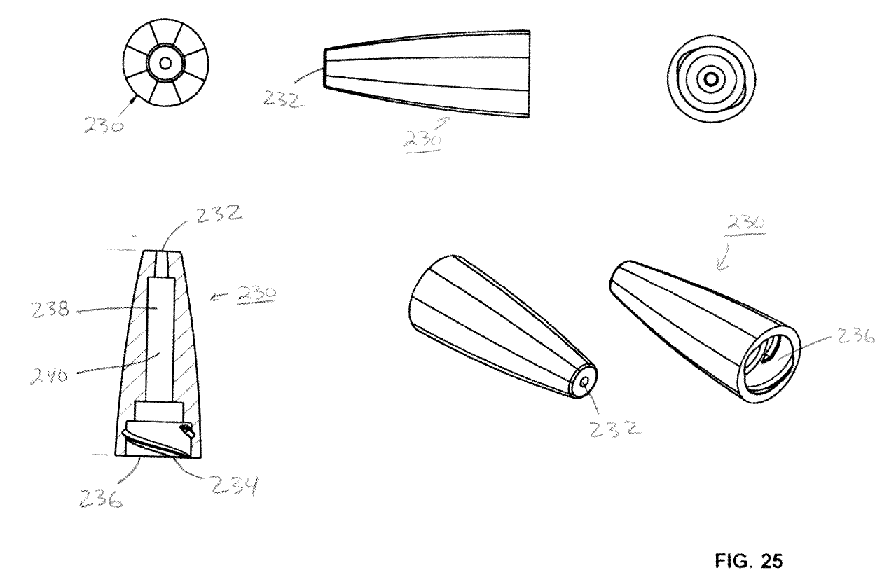

FIGS. 24 and 25 are two different embodiments of a nozzle tip 230. The nozzle tips are interchangeable with the nozzle base 220 and produce different spray patterns depending on the design of the nozzle tip. Generally, each nozzle tip 230 has a tip outlet 232, a female thread 234 at a tip inlet 236, and a mixing chamber 238 in fluid communication with the tip inlet and tip outlet. The fluid communication may be via, for example, flow path 240. A mixing element 242 (see FIG. 20) is placed into the mixing chamber 238, generally through the tip inlet 236. The mixing chamber 238 is generally cylindrical. The shape of the tip outlet 232 affects the spray pattern. For example, in FIG. 24, a fan pattern will arise whereas in FIG. 25, a solid stream or beads can be produced. The cross-sectional width of the nozzle tip 230 at its inlet 236 is greater than the cross-sectional width at the outlet 232.

Referring again to FIG. 22, the snap fasteners 212 of the nozzle base 210 are inserted into the nozzle recesses 54. The mixing element 242 goes into the nozzle tip 230 (two kinds of nozzle tips are illustrated) and the nozzle tip is attached to the nozzle base 210. The pitch of the male thread 216 and female thread 234 can be adjusted to produce the desired seal in less than 360° of rotation.

The resulting dispensing gun has an interior fluid handling cartridge design which is separate from the exterior gun body. Different embodiments and arrangements are contemplated within the spirit of this disclosure. For example, as previously discussed, the hose assembly may be a one-piece design instead of two separate hose barbs as shown in the Figures, or the two needles may be made as a one-piece needle assembly. As another example, while in the Figures the hose barbs 150 are received by sockets 94, 124 in the needles, in other embodiments the connectors 76, 106 of the needles could be received by the hose assembly instead. In other embodiments, a flow connector 60 could be omitted, with the needle valves 72, 102 extending directly into the ports 26 of the external front wall 22. One disadvantage of this latter embodiment, however, is that the two fluid components may react within the front section 40 of the gun body. In other embodiments, the back wall 14 also defines a rear section 44 in the gun body. Hoses may be laid within the parallel chambers 12 in this rear section, either directly attaching to the containers for the fluid components or serving as a “whip” hose for connecting to other hoses attached to the containers for the fluid components.

A second exemplary embodiment of the dispensing gun of the present disclosure comprises (a) a gun body; (b) two needles; (c) a flow connector; and (d) a hose assembly by which the containers containing the A and B components can be attached to the dispensing gun. In this second exemplary embodiment, a socket spring is located within the socket of each needle. It is contemplated that these socket springs reduce or remove the need for a spring between the trigger and the gun handle.

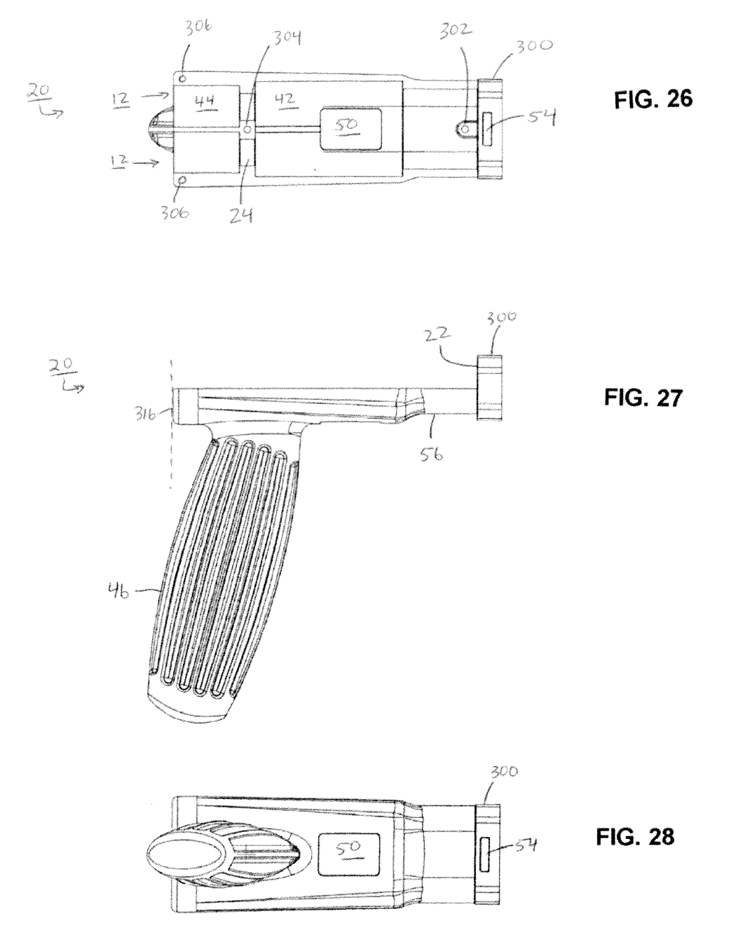

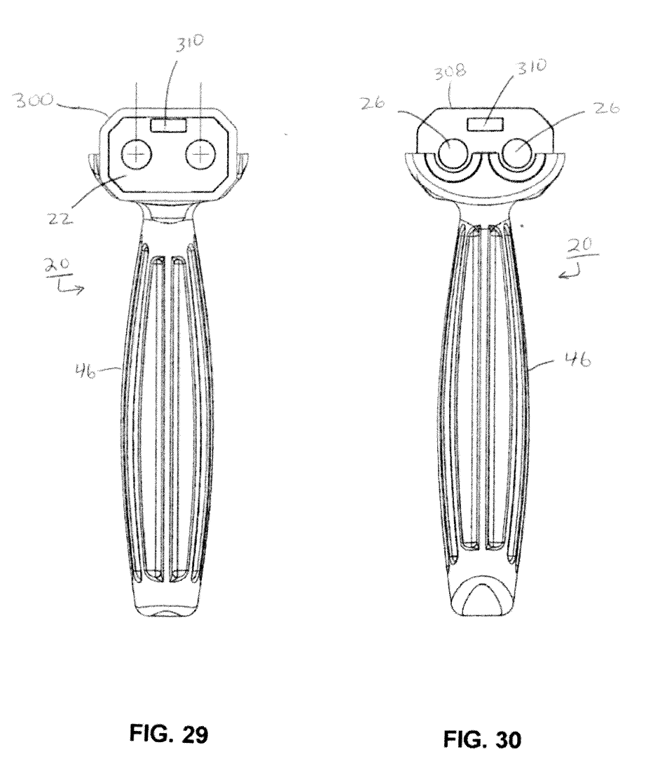

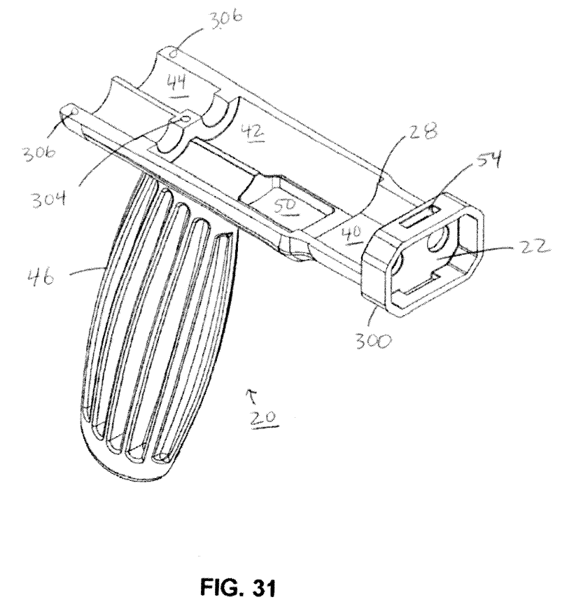

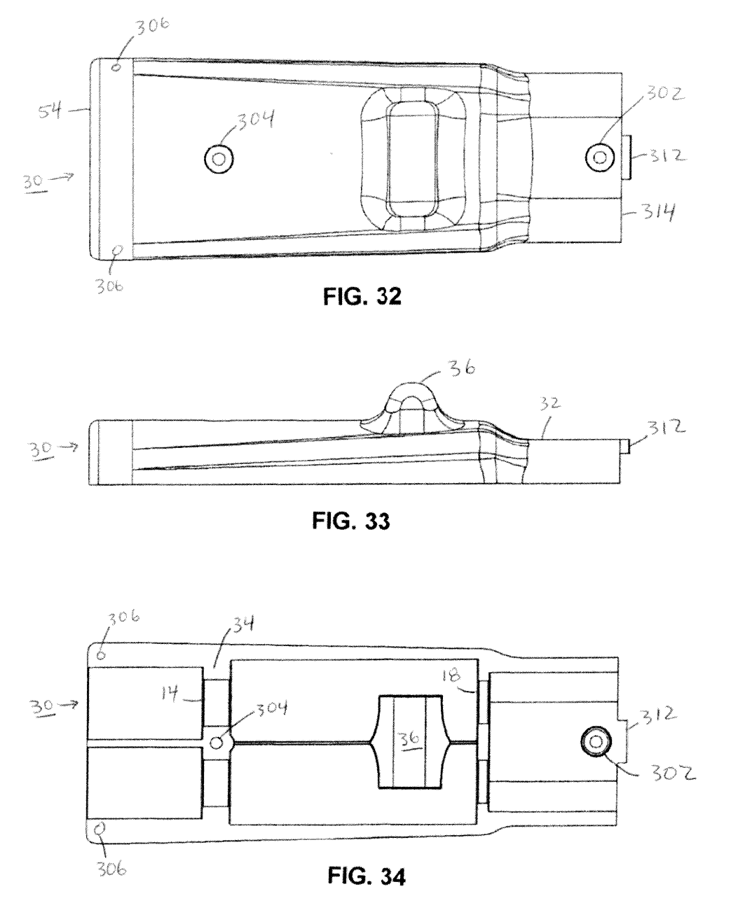

FIGS. 26-31 show different views of the gun base 20, while FIGS. 32-34 show different views of the gun cap 30. Again, these components can be made from a wide variety of materials, including synthetic polymers or elastomeric materials, metals, etc. The components can also be produced and using a wide variety of techniques, such as molding.

The second exemplary gun base 20 depicted in FIGS. 26-31 differs from that depicted in FIGS. 3-9 in several respects. First, the nozzle recesses 54 are located in the front ring wall 300 instead of the external front wall 22. The front ring wall 300 extends forward from the external front wall 22 and, as shown here, has an octagonal shape. Second, an external front wall groove 310 is now present along a top edge 308 of the external front wall 22. As discussed further herein, the external front wall groove 310 will interact with the gun cap 30 to fix the gun cap in place. Third, the handle 46 extends beyond the plane defined by the rear face 316 of gun base/gun body. Fourth, there is no catch 48 on the handle. Compare FIG. 27 with FIG. 3. Finally, the gun base has a front fastener slot 302 located on the inside of the bottom wall 56 in the front section 40, a back fastener slot 304 located in the back wall portion 24 between the parallel chambers 12, and two rear fastener slots 306 located along the back end 52 of the gun base. This means only four fasteners 168 need to be used, instead of the seven fasteners as seen in FIG. 1. In certain embodiments, the gun base has the back fastener slot 304 and the two rear fastener slots 306, but does not have the front fastener slot 302. In other embodiments, the gun base has one front fastener slot 302 and one back fastener slot 304, but does not have the two rear fastener slots 306.

Turning to the second exemplary gun cap 30 and FIGS. 32-34, a few differences are present. Again, the gun cap has a front fastener slot 302, a back fastener slot 304 located in the back wall portion 34 between the parallel chambers 12, and two rear fastener slots 306 in the top wall 32. In addition, the gun cap has a tongue 312 extending from the front end 314 of the gun cap itself. The tongue 312 is inserted into the external front wall groove 310 on the gun base 20 to fix the gun cap in place. Finally, the U-shaped trigger recess 36 extends outwards from the top wall 32. This gives the dispensing gun a unique appearance.

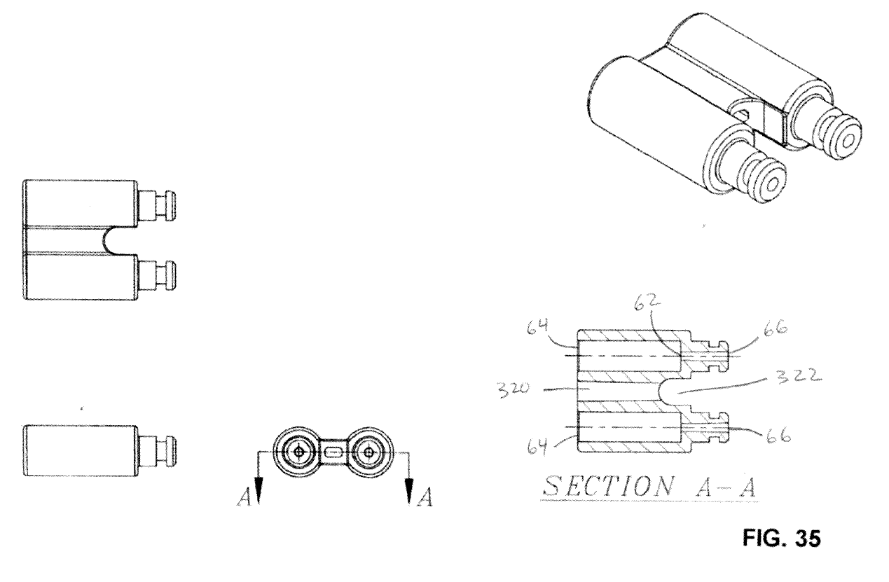

FIG. 35 shows various views of a second exemplary flow connector 60. The flow connector 60 is sized to fit snugly within the front section 40 of the gun body 10. In other words, the flow connector does not move within the front section 40, or is fixed in place between the external front wall 22 and the internal front wall 18. The flow connector contains two parallel dispensing passages 62 which are separate from each other. Each dispensing passage runs from a rear inlet 64 to a forward outlet 66. The forward outlets extend through the ports 26 in the external front wall 22, and in some embodiments beyond the external front wall. The rear inlets are sized to receive the forward section 82 of the needle. A central portion 320 joins the two dispensing passages together. It should be noted also that a fastener slot 322 is removed from the central portion to allow a fastener to pass through the front fastener slots 302 and secure the gun cap 30 to the gun base 20.

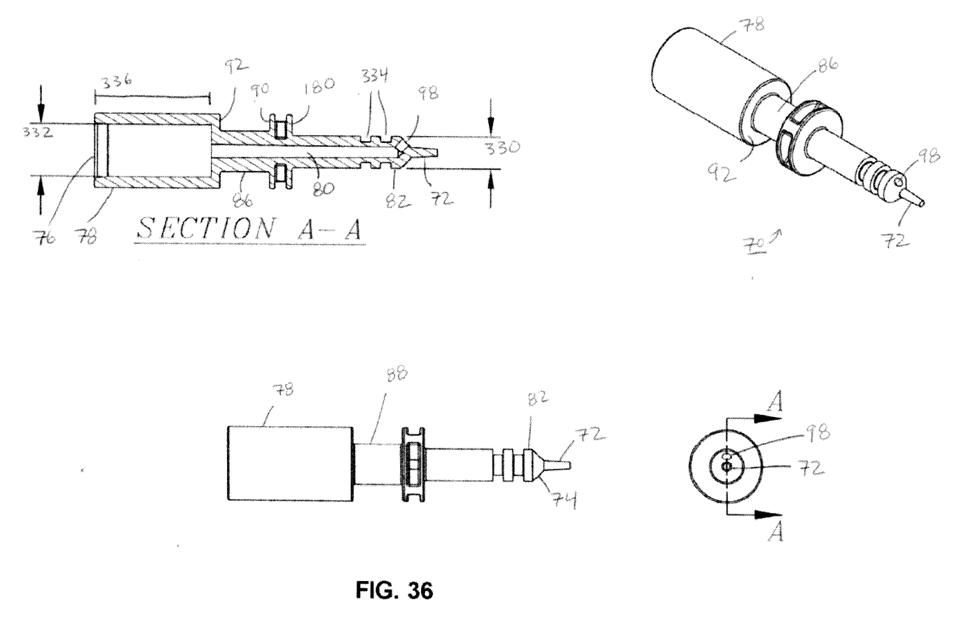

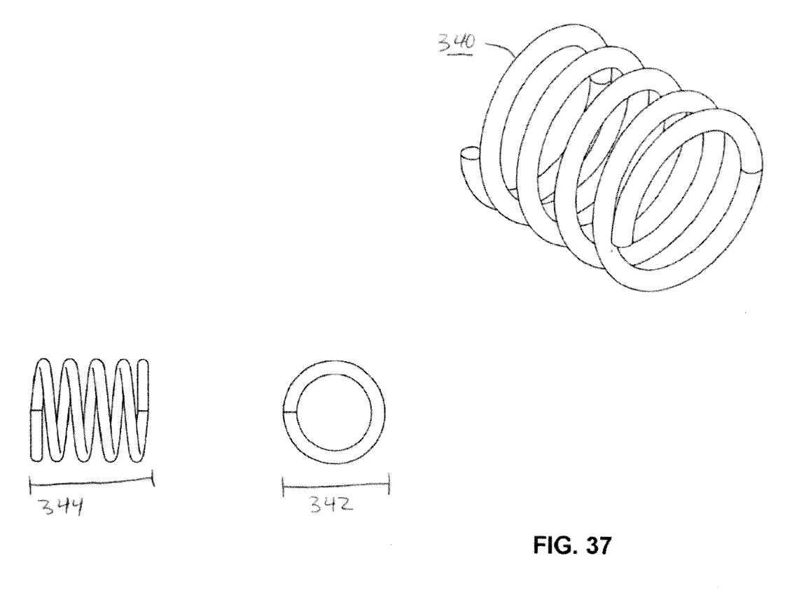

FIG. 36 shows various views of a second exemplary piston or needle 70. Unlike the embodiment described in FIG. 21, in the second exemplary dispensing gun the two needles are substantially identical. The needle has a needle valve 72 from the forward section 82 of the needle. The forward section 82 may have an angled forward wall 74, or alternatively the forward section may be considered as being angled or as having a conical shape with the vertex towards the forward end and the base towards the rearwards end. In specific embodiments, the forward section or forward wall has an angle of from about 40° to about 50°, measured between the longitudinal axis coming from the socket and the forward wall. The rear section 78 is hollow and forms a socket 76. A flow path 80 runs from the rear section 78 to the forward section 82 and out through an outlet 98. Notably, the flow path generally follows the longitudinal axis of the needle until the forward section, where the flow path is angled so that the outlet 98 is located on the angled forward wall 74. Put another way, the flow path exits at an angle to the longitudinal axis. In contrast, in the needles shown in FIGS. 16-17, the flow path is parallel to the longitudinal axis, i.e. a straight line. The needle 70 also has two O-ring grooves 334, instead of just one as in FIGS. 16-17.

FIG. 37 shows various views of a socket spring 340. The socket spring 340 is sized so as to fit within the socket 76 of the needle 70. The socket spring 340 has a diameter 342 and a length 344. Referring back to FIG. 36, the socket 76 has a diameter 332 and a length 336, the diameter being measured perpendicular to the longitudinal axis and the length being measured parallel to the longitudinal axis. The socket spring diameter 342 is substantially equal to or less than the socket diameter 332. The socket spring length 344 is less than the socket diameter 333 to accommodate the hose barb 150 within the socket 76 as well.

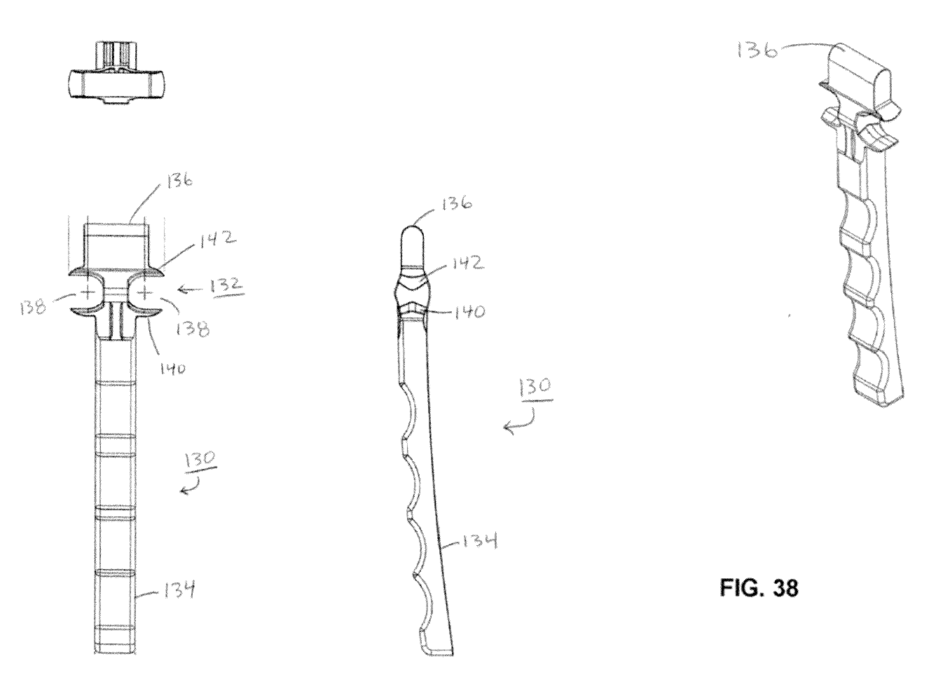

FIG. 38 shows various views of the trigger 130. Again, the trigger comprises a yoke portion 132, a trigger lever 134 extending from the yoke portion, and a trigger pivot 136 extending from the yoke portion opposite the trigger lever 134. The yoke portion 132 has a pair of openings 138 through which the two needles 70 extend. The yoke portion 132 comprises a first crossbar 140 and a second crossbar 142. Here, the first crossbar 140 and second crossbar 142 are of substantially equal length, where the length is measured in the longitudinal direction (i.e. parallel to the two needles). The trigger does not have catch 148 for engaging a spring. The trigger lever 134 may be contoured to conform to the shape of a user's fingers.

In this second exemplary embodiment, the primary seal is formed when needle valve 72 is inserted into forward outlet 66. The force that pushes the needle valve 72 forward is achieved by the pressure of the chemical (A or B) itself. Referring back to FIG. 36, the socket 76 has a surface area in contact with the chemical, and the pressure of the chemical pushes the needle 70 forward. The socket spring 340 inside the needle also assists in biasing the needle towards the safety (closed) position, particularly at low chemical pressures.

To minimize stresses in the dispensing gun, the surface area of the needle creating lateral force is minimized. The angled forward wall 74 reduces the lateral surface area. Put another way, the forward section 82 has a diameter 330 (also measured perpendicular to the longitudinal axis) which is generally minimized and in particular is smaller than the socket diameter 332.

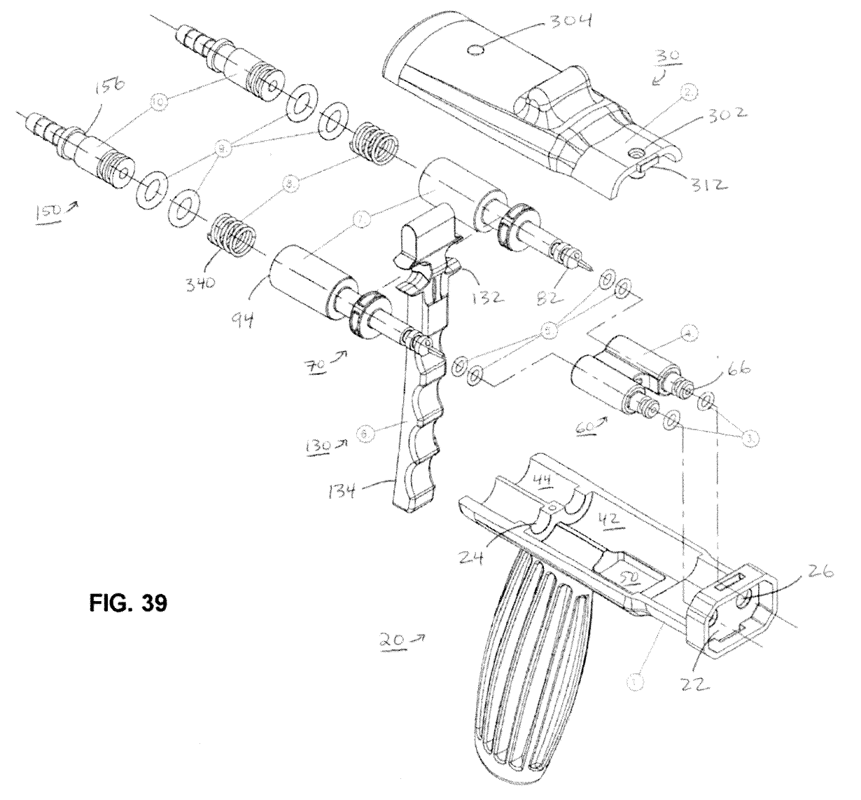

FIG. 39 shows the dispensing gun being assembled. The two needles 70 are inserted into the yoke portion 132 of the trigger 130. Two o-rings are placed on each needle. The forward sections 82 of the needles 70 are inserted into, or received by, the rear inlets 64 of the flow connector 60. Two o-rings are used on the flow connector. Two o-rings are placed on each hose barb 150. A socket spring 340 and a hose barb 150 are received in the socket 94 of a needle.

The sub-assembly of the flow connector 60, needles 70, and hose barbs 150 is then placed in the gun base 20. The trigger cavity 50 is sized so that the forward outlets 66 of the flow connector 60 can be placed into the ports 26 in the external front wall 22 and the trigger lever 134 can be inserted through the trigger cavity 50 while maintaining the sub-assembly. The flow connector 60 fits in the front section 40 and the needles are placed in the middle section 42. The indent 156 of each hose barb is aligned with the back wall portion 24 of the gun base 20, so that the hose barbs do not move in relation to the gun body 10. The needles 70 occupy the parallel chambers 12 in the middle section 42 of the gun body.

The gun cap tongue 312 then engages, or is inserted into, the groove 310 (not shown), and pivoted downwards so the trigger pivot 136 fits into the trigger recess 36. Fasteners are then inserted through the fastener slots 302, 304, 306 as desired.

The socket springs 340, along with the pressure from the chemical, bias the needles into the safety position. In this position, the needle valves 72, 102 are pushed into, or extend into, the two forward outlets 66 of the flow connector 60. Upon a user squeezing the handle 46 and the trigger lever 134 together, the force from the springs and the chemical is overcome, and the needles move into a dispensing position.

In summary, the differences between the first exemplary embodiment (FIGS. 1-25) and the second exemplary embodiments (FIGS. 26-39) are: (1) a spring located inside the socket of the needle/piston instead of on the handle; (2) an angled wall on the forward section of the needle; (3) the outlet on the needle is on the angled wall; (4) a smaller lateral surface area at the front of the needle compared to the rear of the needle (to increase the pressure from the chemical to create a primary seal while minimizing lateral stress); (5) a tongue-and-groove arrangement for the gun cap; (6) the nozzle receiving recesses being located on the front ring wall instead of the external front wall; (7) no catches on the handle and trigger for a spring; (8) the trigger recess being visible as a “hump” on the gun cap; and (9) fewer fasteners needed to secure the gun cap to the gun body.

The dispensing gun of the present disclosure may be useful in applying polyurethane foam, adhesives, elastomers, specialty chemicals, and other coatings. While the dispensing gun may be particularly used in apply polyurethane foam, the gun can generally receive at least two components (such as air, liquids, and possibly particulates) and mix them together. Separate channels are maintained within the gun body for each of the components. The trigger system provides on/off flow and metering capability.

The nozzle and hoses are easily and securely attached to the gun, providing robust connections and leakproof seals. It is also easy to assemble the dispensing gun, change parts, and maintain the gun, allowing for a longer lifetime and cost savings.

One concern which affects many two-component dispensing gun designs is known as crossover. Generally, crossover occurs when one of the fluid components crosses over into the dispensing mechanism in the dispensing gun for the other component. Crossover inside the dispensing gun may occur when the pressure differential between the two fluid components becomes significant or when a blockage in one fluid path forces the fluid component into the fluid path for the other fluid component. The present design prevents crossover within the gun by providing separate flow paths through the gun and moving the mixing chamber into the nozzle, which is easily replaceable. Unused chemicals can also be purged from the gun body and nozzle by attaching an air hose to the gun body or to nozzle base 210.

The dispensing devices or guns may be provided or sold with other equipment. Such a kit may include one or more pressurized containers containing at least two fluid components (e.g., one container containing the two fluid components in separate compartments, or two containers each containing one fluid component). The kit would also include one or more hoses capable of providing a separate channel for each fluid component in the one or more pressurized containers (e.g., a hose having two separate channels inside, or two hoses, one for each fluid component).

The dispensing devices of the present disclosure have been described with reference to exemplary embodiments. Obviously, modifications and alterations will occur to others upon reading and understanding the preceding detailed description. It is intended that the exemplary embodiments be construed as including all such modifications and alterations insofar as they come within the scope of the appended claims or the equivalents thereof.

1. A dispensing gun, comprising:
a body comprising an external front wall having two ports, an internal front wall, and a back wall, the internal front wall and the back wall extending laterally to divide the body into a front section and a middle section;
a first needle and a second needle, each needle comprising a needle valve extending from a forward wall, an outlet on the forward wall, a socket at a rear section of the needle, and a flow path running from the socket to the outlet of the needle;
a flow connector sized to fit within the front section of the body and comprising two parallel dispensing passages, each dispensing passage running from a rear inlet to a forward outlet, the forward outlets extending through the two ports in the external front wall;
a trigger comprising a yoke portion having a pair of openings through which the first and second needles extend, and a trigger lever extending from the yoke portion; and
a first hose barb and a second hose barb, each hose barb comprising a sidewall defining a flow passage and an indent cooperating with the back wall to hold the hose barb in a fixed location, wherein each hose barb is received in the socket of one of the two needles so that the hose barb flow passage aligns with the needle flow path;
wherein the rear inlets of the flow connector receive the forward sections of the first and second needles and the two needle valves are aligned with the two forward outlets; and
wherein the two needles are movable within the middle section between a safety position in which the two needle valves extend into the two forward outlets and a dispensing position permitting flow from the two needle sockets through the two forward outlets.

2. The dispensing gun of claim 1, wherein the back wall of the body also defines a rear section within the body for receiving two hoses.

3. The dispensing gun of claim 1, wherein a forward shoulder on each needle cooperates with an internal surface in the body in the safety position.

4. The dispensing gun of claim 3, wherein the internal surface is the internal front wall.

5. The dispensing gun of claim 3, wherein the internal surface is located between the internal front wall and the back wall.

6. The dispensing gun of claim 3, wherein the forward shoulder on each needle is located between a forward section of the needle and the yoke portion of the trigger.

7. The dispensing gun of claim 3, wherein the forward shoulder on each needle is located between the yoke portion of the trigger and the socket of the needle.

8. The dispensing gun of claim 1, wherein a rear shoulder on each needle cooperates with the back wall of the body in the dispensing position.

9. The dispensing gun of claim 1, wherein the first needle has a prong, and the second needle has a slot for engaging the prong.

10. The dispensing gun of claim 1, wherein the trigger further comprises a trigger pivot extending from the yoke portion opposite the trigger lever, wherein the trigger pivot extends into a recess in a top wall of the body.

11. The dispensing gun of claim 1, wherein the yoke portion comprises a first crossbar from which a trigger pivot extends and a second crossbar from which the trigger lever extends, the second crossbar being longer than the first crossbar.

12. The dispensing gun of claim 1, wherein each needle further comprises a reduced width portion for engaging the yoke portion of the trigger.

13. The dispensing gun of claim 1, wherein the body is formed from a gun cap and a gun base.

14. The dispensing gun of claim 13, wherein the external front wall is located on the gun base, the external front wall further comprises a groove, the gun cap comprises a tongue, and the gun cap tongue engages the external front wall groove.

15. The dispensing gun of claim 1, wherein the first needle and the second needle each further comprise a socket spring located within the socket.

16. The dispensing gun of claim 1, wherein the forward wall of each needle is angled.

17. The dispensing gun of claim 1, wherein the trigger further comprises a trigger pivot extending from the yoke portion opposite the trigger lever, wherein the trigger pivot extends into a trigger recess extending beyond a top wall of the body.

18. A dispensing gun, comprising:
a body comprising an external front wall having at least two ports, an internal front wall, and a back wall, the internal front wall and the back wall extending laterally to divide the body into a front section and a middle section;
a needle assembly comprising at least two needle valves extending from a forward wall, at least two connectors at a rear section of the needle assembly, and at least two separate flow paths running from the at least two connectors to a forward section of the needle; and
a hose assembly for receiving at least two hoses, the hose assembly including at least two separate flow passages and an indent cooperating with the back wall to hold the hose assembly in a fixed location, each flow passage engaging one of the connectors of the needle assembly and aligning with the needle flow path;
the needle assembly being movable within the middle section between a safety position in which the at least two needle valves prevent flow through the at least two ports of the external front wall and a dispensing position permitting flow from the at least two needle connectors to the at least two ports of the external front wall.

19. The dispensing gun of claim 18, further comprising a flow connector sized to fit within the front section of the body, the flow connector including at least two parallel dispensing passages, each dispensing passage running from a rear inlet to a forward outlet, the forward outlets extending through the two ports in the external front wall, the rear inlet being configured to engage the forward section of the needle assembly so that each flow path of the needle assembly aligns with one dispensing passage.

20. A kit, comprising:
the dispensing gun of claim 1;
one or more pressurized containers containing at least two fluid components; and
one or more hoses capable of providing a separate channel for each fluid component in the one or more pressurized containers.
